(19) United States
(12) Patent Application Publication
(10) Pub. No.: US 2022/0233975 A1
(43) Pub. Date: Jul. 28, 2022

(54) APPARATUS AND METHODS FOR CLEANING POOL AND SPA FILTERS

(71) Applicant: Life Made Better, Intl. LLC, Bonham, TX (US)

(72) Inventors: Christopher Franck, Fort Mill, SC (US); Austin Lewis, Durham, NC (US); Brandt Strieby, Bonham, TX (US)

(21) Appl. No.: 17/585,984

(22) Filed: Jan. 27, 2022

Related U.S. Application Data
(60) Provisional application No. 63/142,021, filed on Jan. 27, 2021.

(51) Int. Cl. B01D 24/46

(52) U.S. Cl. CPC B01D 24/4684; B01D 24/4673

(57) ABSTRACT

An apparatus for cleaning pool or spa filters includes: a housing; a turntable assembly in the housing, the turntable assembly configured to receive a filter thereon; and a fluid assembly on the housing configured to receive liquid from a liquid source. The fluid assembly includes: a spin jet configured to spray the liquid on the turntable such that the turntable and the filter thereon spin; and at least one power jet configured to spray the liquid on and/or through the filter while the turntable assembly and the filter spin.

This application claims priority from U.S. Provisional Application No. 63/142,021, filed Jan. 27, 2021, the disclosure of which is incorporated by reference in its entirety.

### BACKGROUND

Cartridge style pool and spa filters are typically cleaned by hand (e.g., with a hose). This can be time-consuming, ineffective, and can reduce the life of the filter and degrade the quality of the water in the pool or spa. It would be desirable to have an automatic system to clean the filter efficiently to avoid these issues.

### SUMMARY

Some embodiments of the present invention are directed to an apparatus for cleaning pool or spa filters includes: a housing; a turntable assembly in the housing, the turntable assembly configured to receive a filter thereon; and a fluid assembly on the housing configured to receive liquid from a liquid source. The fluid assembly includes: a spin jet configured to spray the liquid on the turntable such that the turntable and the filter thereon spin; and at least one power jet configured to spray the liquid on and/or through the filter while the turntable assembly and the filter spin.

Some other embodiments of the present invention are directed to a method for cleaning a cartridge style filter for a swimming pool or a spa. The method includes: providing an apparatus comprising an enclosure, a turntable assembly in the enclosure, and a fluid assembly in the enclosure; placing the filter on the turntable assembly; connecting a hose to the fluid assembly to provide water to the fluid assembly; spraying water from the fluid assembly to a side of the turntable assembly such that the turntable assembly and filter rotate; and spraying water from the fluid assembly onto the filter while the turntable assembly and the filter rotate to thereby clean the filter of dirt and debris.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIG. 1 is a front perspective view of an apparatus configured to clean swimming pool and spa filters according to some embodiments.

FIG. 2 is a rear perspective view of the apparatus of FIG. 1.

FIG. 3 is a top perspective view of a cartridge style pool filter.

FIG. 4 is an exploded view of a turntable assembly of the apparatus of FIG. 1.

FIGS. 5A and 5B are fragmentary perspective views of the turntable assembly of FIG. 4 illustrating adjustable stabilizing pins.

FIG. 6 is a perspective view of a fluid assembly of the apparatus of FIG. 1.

FIG. 7 is a fragmentary perspective view of the apparatus of FIG. 1 according to some other embodiments.

FIG. 8 is a fragmentary front view of the apparatus of FIG. 1 according to some other embodiments.

FIG. 9 is an exploded view of a turntable assembly of the apparatus of FIG. 1 according to some other embodiments.

FIG. 10 is a rear perspective view of an apparatus configured to clean swimming pool and spa filters according to some other embodiments.

FIG. 11 is a front perspective view of the apparatus of FIG. 10 with a front cover shown transparent to better illustrate other features.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

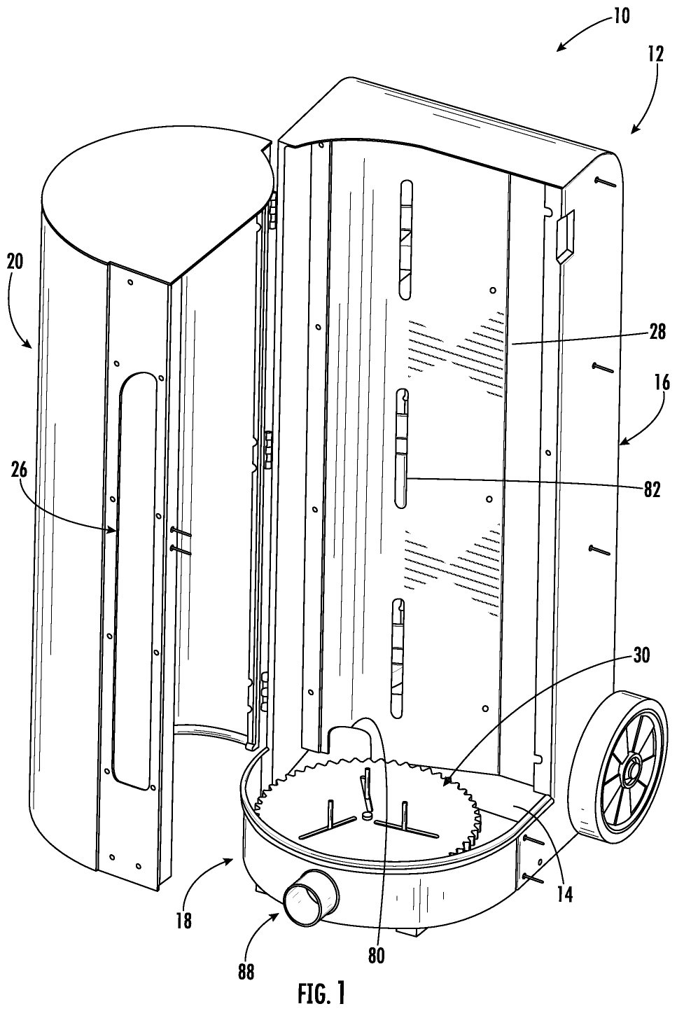

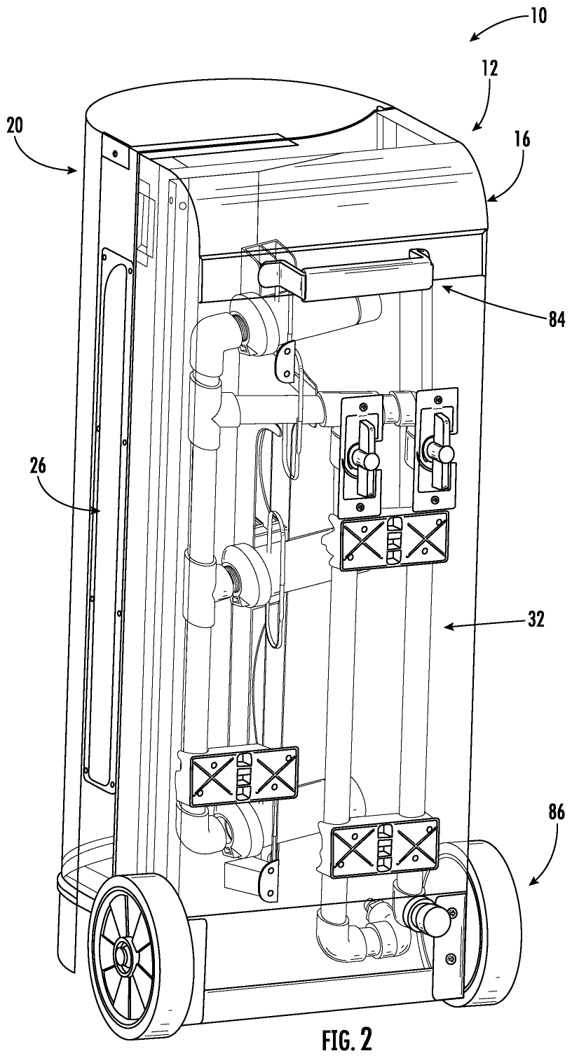

An apparatus 10 for cleaning swimming pool and spa filters is illustrated in FIGS. 1 and 2. The apparatus 10 includes a housing or enclosure 12. The housing 12 may include a base 14, an upper or rear chassis 16 extending upwardly from the base 14, and a lower or front chassis 18 extending upwardly from the base 14. The rear chassis 16 is shown transparent in FIG. 2 to better illustrate the components held therein.

Referring to FIG. 1, the housing 12 includes a door 20 that is hingedly or pivotally attached to the rear chassis 16. The door 20 is movable between an open position as shown in FIG. 1 and a closed position as shown in FIG. 2. As described in more detail below, the door 20 is moved to the closed position to enclose a filter in the housing during a cleaning operation and the door 20 is moved to the open position to prepare for a cleaning operation or to remove a cleaned filter.

The door 20 includes a window 26 to, for example, allow a user to observe a cleaning operation.

The housing 12 also includes a central panel 28 that provides mechanical strength for various components including the rear chassis 16. The panel 28 also separates the cleaning chamber including a turntable assembly 30 and a rear space holding a fluid assembly 32 (FIG. 2).

The various components of the housing 12 may be made of any suitable material. In some embodiments, at least some of the components of the housing 12 are made of powder coated aluminum to provide durability and resist corrosion and fading.

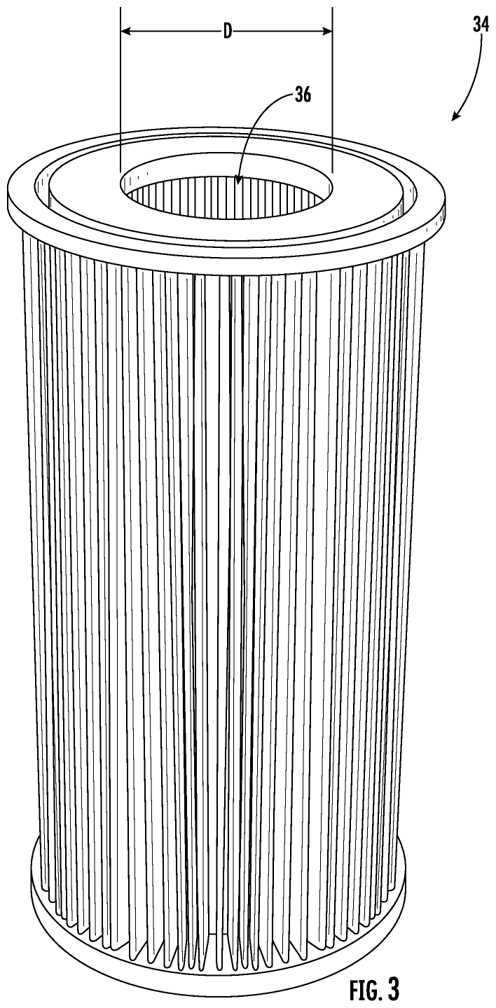

The apparatus 10 is designed for cleaning cartridge type filters for swimming pools and spas. An example cartridge filter 34 is illustrated in FIG. 3. The filter 34 is cylindrical and includes a hollow inner core 36. The inner core 36 has a diameter D. As understood by those of skill in the art, these filters come in a variety of sizes including different heights and different inner core diameters. As described herein, the apparatus 10 is designed to accommodate and efficiently clean the differently sized filters.

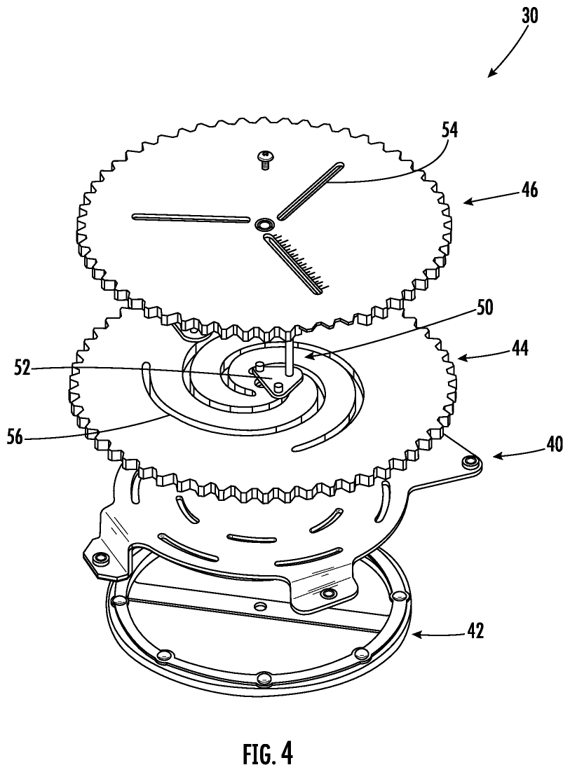

Referring to FIGS. 1 and 4, the turntable assembly 30 is on the base 14. The turntable assembly 30 includes a base plate 40 for connection to the base 14, a bearing assembly 42 including a plurality of bearings on the base plate 40, a scroll plate or lower plate 44 on the base plate 40 and/or the bearing assembly 42, and a slide plate or upper plate 46 on the scroll plate 44.

The turntable assembly 30 further includes a plurality of stabilizing pins 50 that extend upwardly from the slide plate 46. Each pin 50 is connected by a bracket or support 52 to the scroll plate 44 and extends upwardly through a straight elongated slot 54 defined in the slide plate 46. A bottom portion of each pin 50 is received in a spiral slot 56 defined in the scroll plate 44.

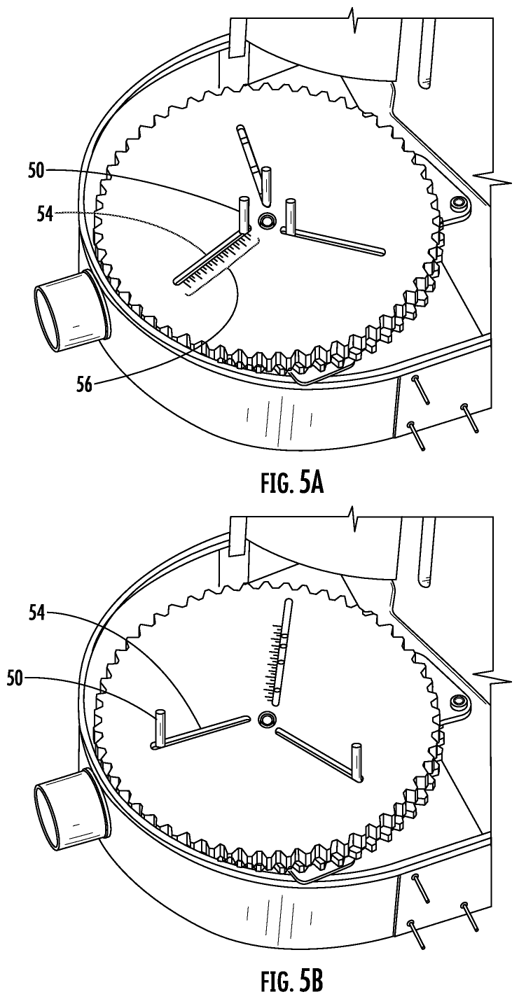

Referring to FIGS. 5A and 5B, the pins 50 are radially translatable in the slots 54 between a first position (FIG. 5A) and a second position (FIG. 5B). A user may position the pins to substantially match the diameter D of the filter inner core 36 (FIG. 3). The stabilizing pins help stabilize the filter when the turntable assembly 30 with the filter thereon is rotating, as described in more detail below.

There may be indicia 56 such as a scale that helps a user move the pins to the correct position. For example, the indicia may correspond to the diameter of the filter inner core.

In some embodiments, the pins 50 may be positioned by relative movement (rotation) of the scroll plate 44 and the slide plate 46. For example, a user may hold the scroll plate 44 in place and rotate the slide plate 46 such that the pins 50 translate radially in the slots 54.

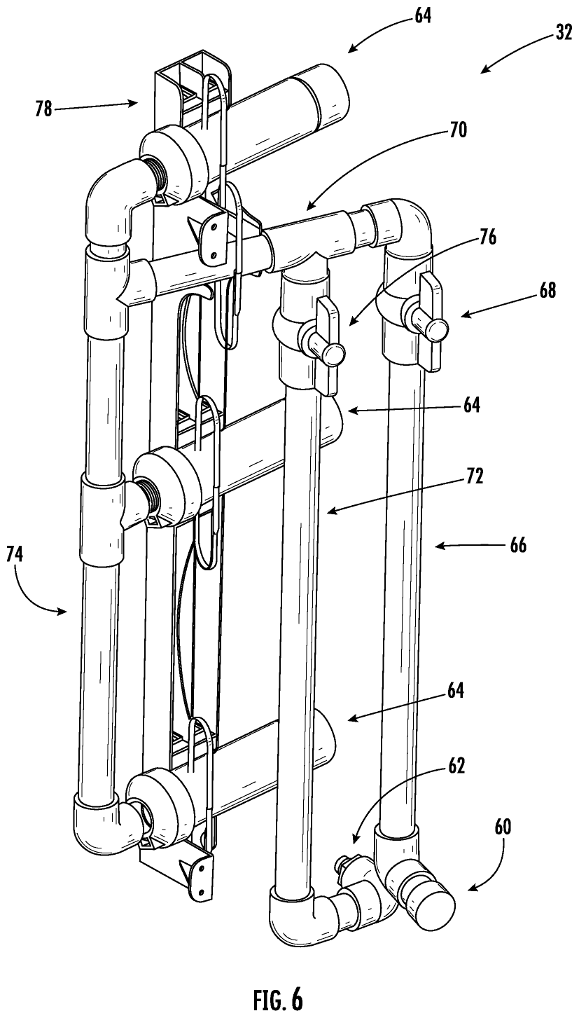

Referring to FIGS. 2 and 6, the fluid assembly 32 includes a hose connector 60, a spin jet or spin jet nozzle 62, and one or more power jets or power jet nozzles 64. The hose connection 60 is configured to receive a garden hose for water input into the fluid assembly 32. The spin jet 62 is configured to spray water onto a side of the turntable assembly 30 to spin the turntable (and any filter installed thereon). The power jets 64 are configured to spray water onto and/or into the filter as it is spun by the turntable assembly 30.

Referring to FIG. 6, the fluid assembly 32 includes a water input line or pipe 66. A clean valve 68 may be positioned in the water input line 66. A distribution line or pipe 70 extends from the input line 66 and a spin jet line or pipe 72 and a power jet line or pipe 74 branch from the distribution line 70. The spin jet line 72 supplies water to the spin jet 62 and the power jet line 74 supplies water to the power jets 64. A spin valve 76 may be positioned in the spin jet line 72. As shown in FIG. 6, the fluid assembly includes a plurality of fittings such as elbows and tees as will be understood by one of ordinary skill in the art.

A bracket 78 connects the fluid assembly 28 to the panel 28 (FIG. 1).

Referring to FIGS. 1 and 6, the panel 28 includes an opening 80 at a bottom thereof and the spin jet 62 sprays water through the opening 80 to turn the turntable assembly 30. Note that the spin jet 62 and opening 80 are off to the side such that water impinges the side of the turntable assembly 30 at an angle to facilitate rotation of the turntable assembly.

The panel 28 also includes a plurality of slots 82 and each power jet 64 sprays water through one of the slots 82. The slots 82 may be elongated and, in some embodiments, the power jets may articulate or rotate in two opposite directions such that the water jets move up and down for a larger cleaning area.

Referring to FIG. 2, the apparatus 10 may include a handle 84 and wheels 86 connected to the housing 12 (e.g., the rear chassis 16). The handle 84 and/or the wheels 86 may enhance portability.

Referring to FIG. 1, the apparatus 10 may include a drain 88 to drain water during and/or after operation. The drain may extend through the housing 12 (e.g., the front chassis 18). A drain pipe and/or pool backwash hose may be attached to the drain 88 to direct water, dirt, and debris away from the unit and to a desired location.

Use of the apparatus will now be described in more detail with reference to FIGS. 1-6. A user may first turn the clean valve 68 and the spin valve 76 to the OFF position before attaching a garden hose to the hose connector 60. The user may then turn on the water at the source. The door 20 may then be moved to the open position (FIG. 1). The user may then adjust the stabilizing pins 50 to match the diameter of the inner core of the of the filter to be cleaned. The user may then place a dirty filter on the turntable assembly 30 while ensuring that the pins 50 fit inside the inner core of the filter. The door 50 may then be moved to the closed position (FIG. 2). The spin valve 76 may be turned to the ON position such that water is sprayed from the spin valve 62 and the turntable assembly 30 and the filter thereon spin. The clean valve 68 may then be turned to the ON position such that water is sprayed from the power jets 64 to begin cleaning. The spin valve 76 may be adjusted to achieve a relatively fast but stable spin. The clean valve may be turned to the OFF position after the filter is clean (e.g., about 5-8 minutes). The user may then open the door 50 and remove the clean filter. These steps can be repeated to clean additional filters.

In some embodiments, the turntable assembly may be motor driven and the spin jet may be omitted. In some embodiments, there may be more than one turntable assembly in the housing so that more than one filter can be cleaned during a single cleaning cycle. The multiple turntable assemblies may be motor driven or more than one spin jet may be provided.

The apparatus described herein provide for fast, easy cleaning of pool and spa cartridge filters. It deep cleans virtually any pool or spa cartridge filter. Within minutes, it removes dirt, debris, and contaminants (without damaging the filter) for more efficient filtration and clearer, cleaner swimming water. This is just a fraction of the time needed with conventional methods. It uses water more efficiently than cleaning by hand, saving hundreds of gallons per year.

Cartridge filters last longer with regular, thorough cleaning. Cleaner filters increase the filtration system's efficiently and reduce the need for added chemicals.

The apparatus described herein deep cleans filters with a power wide dispersion spray pattern. According to some embodiments, three power jet spray nozzles are used to remove tough-to-reach dirt and debris.

The apparatus accommodates up to 99% of pool and spa cartridge filters on the market today. The size of the housing and the provision of multiple power jet spray nozzles helps ensure than filters of any height and effectively cleaned. The stabilizing pins may help ensure that the filter fits securely inside regardless of the size or brand.

In some embodiments, the stabilizing pins may be omitted. A hydrodynamic solution (e.g., a hydrodynamic brake) may be employed for controlling the speed of the turntable assembly and creating a stable filter spin.

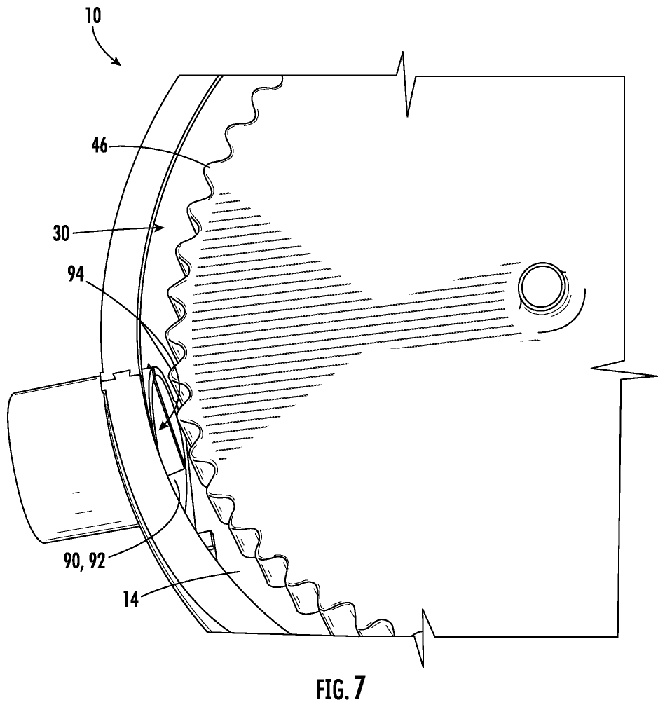

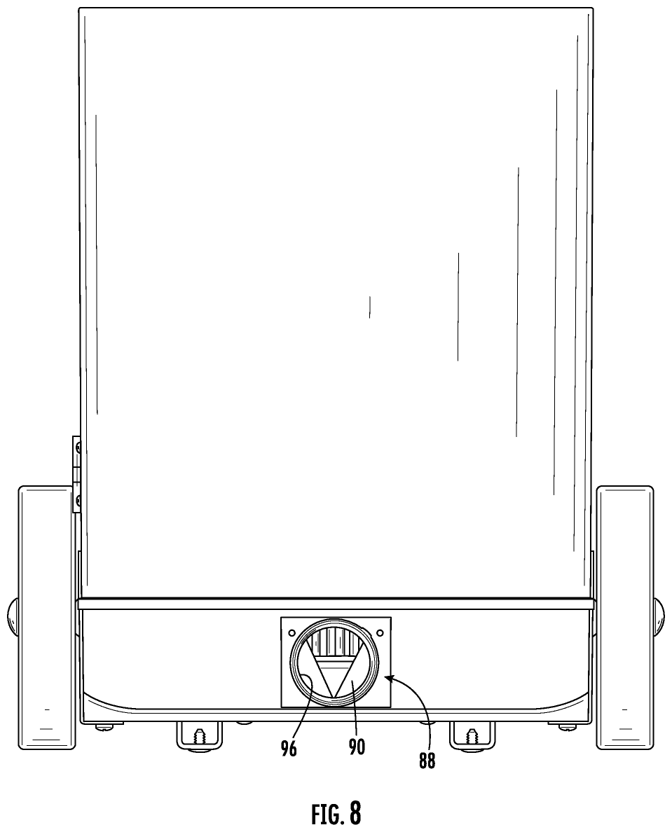

Referring to FIGS. 7 and 8, a hydrodynamic dam 90 may be on the base 14. The dam 90 (which may be referred to as a “V-dam”) includes a body 92 defining an opening 94. The opening 94 may be V-shaped. The dam 90 is between the turntable assembly 30 and the drain 88. The dam 90 may partially occlude an opening 96 of the drain 88.

In operation, the dam 90 allows water to back up (or pool) just enough to interfere with the rotation of the upper plate 46 of the turntable assembly 30. The benefit of this approach is that the system self regulates; the faster the upper plate 46 spins the more drag the water around the upper plate 46 creates. This results in a constant spin speed amongst widely varying conditions.

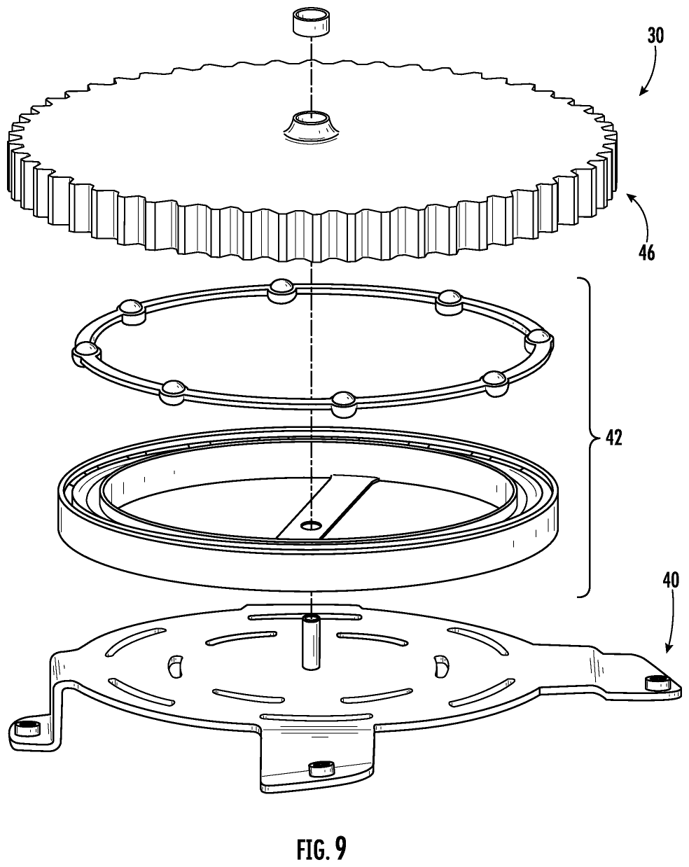

FIG. 9 is an exploded view of the turntable assembly 30 without the stabilizing pins. Referring to FIGS. 4 and 9, it can be seen that the scroll plate 44 is omitted in the embodiment of FIG. 9. In this embodiment, the turntable assembly 30 includes the base plate 40 for connection to the base 14, the bearing assembly 42, and the upper plate 46 (which may be referred to as a “platform”). A level 98 such as a bullseye bubble level may also be included on the upper plate or platform 46. The level 98 allows a user to easily tell if the unit is level.

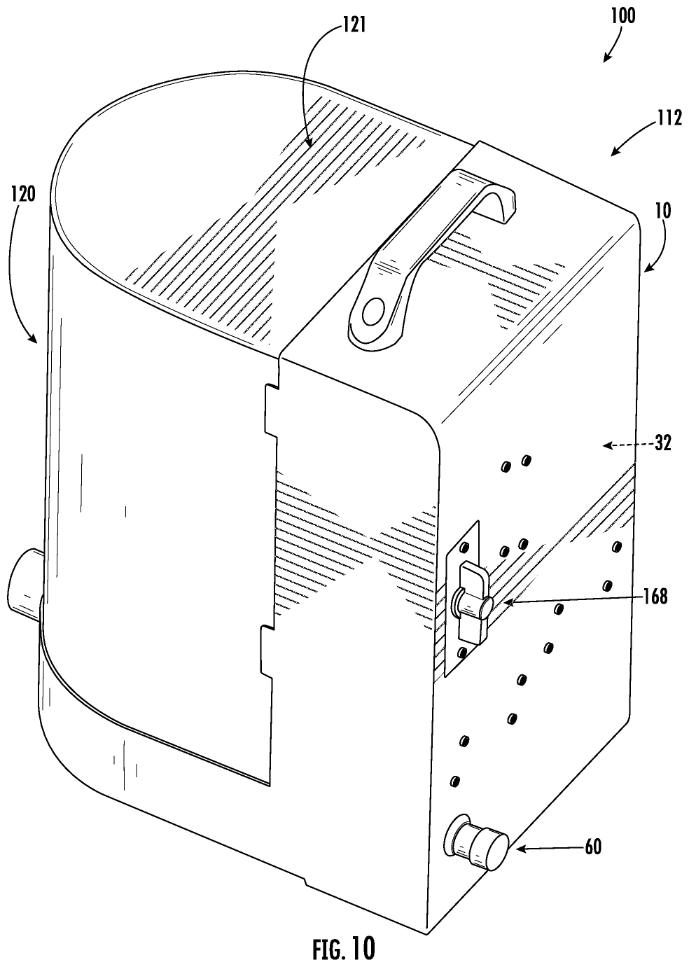

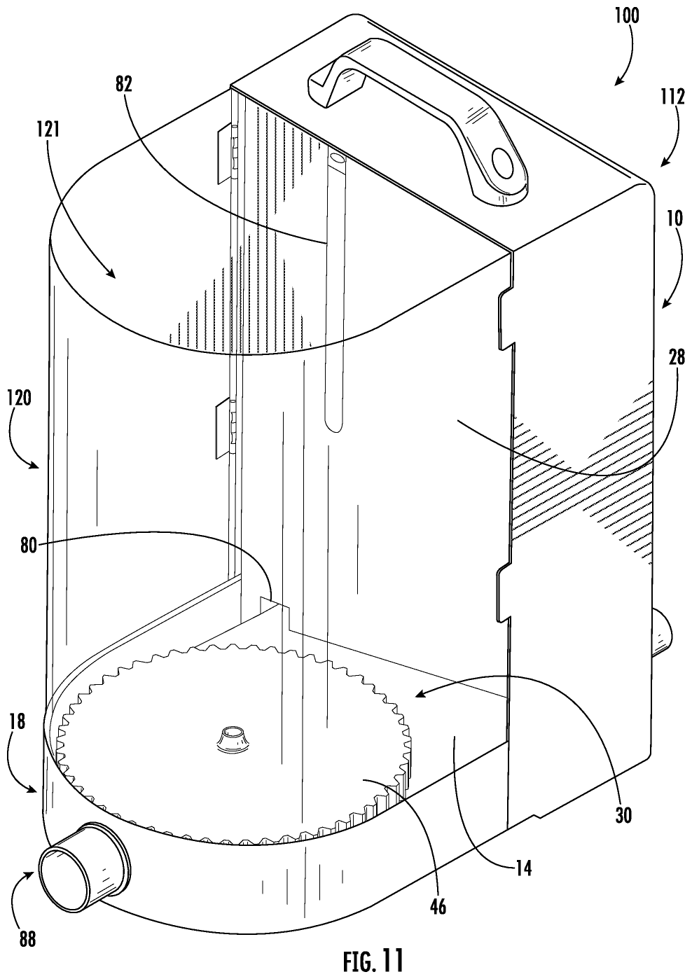

An apparatus 100 for cleaning swimming pool and spa filters according to some other embodiments is illustrated in FIGS. 10 and 11. The apparatus 100 is substantially similar to the apparatus 10 described above with the following differences. A front cover 120 is provided that, together with the rear chassis 16, serves to form a partial enclosure housing 112 for the filter being cleaned. The front cover 120 may be slidably installed and removed (e.g., down and up) and may engage the rear chassis 16.

The front cover 120 includes a top opening 121. In some embodiments, the apparatus 100 is shorter and more compact than the apparatus 10 described above. Therefore, the filter being cleaned may protrude through the top opening 121. The user may clean the filter in two steps. First, the user inserts filter through the opening 121, places the filter on the platform 46, and runs a clean cycle as described herein. Second, the user lifts the filter through the opening 121, rotates the filter, inserts the filter through the opening 121 with the opposite end of the filter on the platform 46, and runs another clean cycle.

The front cover 120 may be formed of a metal such as aluminum or may be formed of a polymer. In some embodiments, the front cover 120 is a thermoformed plastic sheet.

The fluid assembly 32 may be the same or similar to that described above. In some embodiments, the fluid assembly 32 may include only one ON/OFF valve 168 instead of separate clean and spin valves. This may simplify the plumbing of the fluid assembly 32.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

What is claimed is:

1. An apparatus for cleaning pool or spa filters, comprising:
a housing;
a turntable assembly in the housing, the turntable assembly configured to receive a filter thereon; and
a fluid assembly on the housing configured to receive liquid from a liquid source, the fluid assembly comprising:
a spin jet configured to spray the liquid on the turntable such that the turntable and the filter thereon spin; and
at least one power jet configured to spray the liquid on and/or through the filter while the turntable assembly and the filter spin.

2. The apparatus of claim 1 wherein the housing comprises a base on which the turntable assembly is situated, wherein a drain is on the housing, and wherein a dam comprising a body and an opening is on the base between the turntable assembly and the drain.

3. The apparatus of claim 2 wherein the dam is adjacent the drain and partially occludes an opening of the drain.

4. The apparatus of claim 1 wherein the at least one power jet comprises a plurality of vertically aligned power jets.

5. The apparatus of claim 1 wherein the at least one power jet rotates upwardly and downwardly to provide a wide dispersion spray pattern.

6. The apparatus of claim 1 wherein the housing comprises a rear chassis and a door connected to the chassis, wherein the door is movable between an open position and closed position, and wherein, in the closed position, the chassis and the door define an enclosed space.

7. The apparatus of claim 6 wherein the housing comprises a panel between the chassis and the door, wherein the door and the panel define a first space in which the turntable assembly is held, and wherein the chassis and the panel define a second space in which the fluid assembly is held.

8. The apparatus of claim 7 wherein the panel includes an opening at a bottom portion thereof through which the spin jet sprays the liquid, and wherein the panel includes at least one elongated slot at a central and/or upper portion thereof through which the at least one power jet sprays the liquid.

9. The apparatus of claim 6 wherein the housing comprises a front chassis surrounding the base, and wherein the apparatus further comprises a drain at the front chassis.

10. The apparatus of claim 1 wherein the spin jet is positioned to spray a jet of the liquid onto a side of the turntable assembly at an oblique angle.

11. The apparatus of claim 1 wherein the fluid assembly comprises a spin valve configured to modulate flow of the liquid from the spin jet and/or a clean valve configured to modulate flow of the liquid from the at least one power jet.

12. The apparatus of claim 1 wherein the apparatus does not require electricity or other power input to operate.

13. The apparatus of claim 1 wherein an opening at a top of the housing configured for placing the filter on and removing the filter from the turntable assembly.

14. The apparatus of claim 1 wherein the turntable assembly further comprises a plurality of stabilizing pins that are configured to be received inside an inner core of the filter to stabilize the filter while the turntable assembly and the filter spin.

15. The apparatus of claim 14 wherein the stabilizing pins are adjustable and movable radially to accommodate a plurality of differently sized filters.

16. A method for cleaning a cartridge style filter for a swimming pool or a spa, the method comprising:
providing an apparatus comprising a housing, a turntable assembly in the housing, and a fluid assembly in the housing;
placing the filter on the turntable assembly;
connecting a hose to the fluid assembly to provide water to the fluid assembly;
spraying water from the fluid assembly to a side of the turntable assembly such that the turntable assembly and filter rotate; and
spraying water from the fluid assembly onto the filter while the turntable assembly and the filter rotate to thereby clean the filter of dirt and debris.

17. The method of claim 16 further comprising pooling water in the housing to interfere with the rotation of the turntable assembly to thereby provide a constant rotation speed.

18. The method of claim 16 wherein the housing comprises a top opening, and wherein placing the filter on the turntable assembly comprises inserting the filter through the top opening.

19. The method of claim 16 wherein the turntable assembly comprises a plurality of stabilizing pins extending upwardly from an upper plate of the turntable assembly, wherein the method comprises adjusting a radial position of the plurality of stabilizing pins to substantially match a diameter of an inner core of the filter, and wherein placing the filter on the turntable assembly comprises receiving the pins inside the inner core of the filter.

20. The method of claim 19 wherein the turntable assembly comprises a lower plate, and wherein adjusting the radial position of the plurality of stabilizing pins comprises holding one of the lower plate and the upper plate in place and rotating the other one of the lower plate and the upper plate.
